(19) United States
(12) Patent Application Publication
(10) Pub. No.: US 2011/0301852 A1
(43) Pub. Date: Dec. 8, 2011

(54) Systems And Methods For Estimating Stability Of A Continuous Wavelet Transform

(75) Inventor: Braddon M. Van Slyke, Arvada, CO (US)

(73) Assignee: Nellcor Puritan Bennett LLC, Boulder, CO (US)

(21) Appl. No.: 12/794,205

(22) Filed: Jun. 4, 2010

(51) Int. Cl. G06F 19/00

(52) U.S. Cl. 702/19

(57) ABSTRACT

Methods and systems are disclosed for analyzing a physiological signal obtained from a patient. The physiological signal is transformed using a continuous wavelet transform to generate a transformed signal, and a scalogram is generated from the transformed signal. A region of relative high energy in the scalogram is identified, and dimension information regarding the region is determined. The dimension information is processed to determine physiological information about the patient and confidence information regarding the signal. A storage device coupled to the electronic processing equipment may be used to store the physiological and confidence information.

### SUMMARY

The present disclosure relates to signal processing and analysis and, more particularly, the present disclosure relates to systems and methods for analyzing a continuous wavelet transform of, for example, a physiological signal.

A continuous wavelet transform of a signal may be at least partially represented in the form of a scalogram having as its axes at least scale and time. Signals that are more or completely random in nature will show energy that is more distributed through a scalogram. A signal that contains periodic components will show more concentrated energy in certain scales and/or regions of a scalogram.

In some embodiments, the present disclosure relates to a system for analyzing a physiological signal obtained from a patient. The system includes electronic processing equipment and a storage device coupled to the electronic processing equipment. The electronic processing equipment may include specialized processing hardware and software. The electronic processing equipment may be capable of transforming the physiological signal using a continuous wavelet transform to generate a transformed signal. The electronic processing equipment may be capable of generating a scalogram from the transformed signal.

The electronic processing equipment may be capable of identifying a region of relative high energy in the scalogram. In some embodiments, the electronic processing equipment may be capable of searching for a region of relative high energy in a range of scales associated with a physiological function such as respiration or physiological pulses. The electronic processing equipment may be capable of determining dimension information regarding the region. In some embodiments, the dimension information includes length information and width information. The length information may include a length of the region along a time axis of the scalogram. The width information may include a width of the region along a scale axis of the scalogram.

The electronic processing equipment may be capable of processing the dimension information to determine physiological information about the patient. In some embodiments, the electronic processing equipment may be capable of calculating a ratio of the length to the width of a region of relative high energy. The calculated ratio may be compared to a threshold ratio. In some embodiments, the signal may be a photoplethysmograph (PPG) signal, and the electronic processing equipment may be capable of determining a respiration state of the patient based at least in part on the comparison of ratios.

In some embodiments, the physiological information may be stored in the storage device coupled to the electronic processing equipment. In some embodiments, the system may include a display device coupled to the storage device on which the physiological information is displayed.

In some embodiments, the electronic processing equipment may be capable of processing the dimension information to determine confidence information regarding the physiological signal. In some embodiments, the determining of confidence information may include assigning a level of confidence to the physiological signal proportional to the difference between the calculated ratio and the threshold ratio. In some embodiments, the electronic processing equipment may be capable of processing the dimension information to determine physiological information.

In some embodiments, the confidence information may be stored in the storage device coupled to the electronic processing equipment. In some embodiments, the storage device may store signal information, including appropriate ranges of scales on the scalogram for different types of signals. In some embodiments, the system may include a display device coupled to the storage device on which the confidence information is displayed.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 shows an illustrative pulse oximetry system in accordance with an embodiment;

FIG. 2 is a block diagram of the illustrative pulse oximetry system of FIG. 1 coupled to a patient in accordance with an embodiment;

FIGS. 3(a) and 3(b) show illustrative views of a scalogram derived from a PPG signal in accordance with an embodiment;

FIG. 3(c) shows an illustrative scalogram derived from a signal containing two pertinent components in accordance with an embodiment;

FIG. 3(d) shows an illustrative schematic of signals associated with a ridge in FIG. 3(c) and illustrative schematics of a further wavelet decomposition of these newly derived signals in accordance with an embodiment;

FIGS. 3(e) and 3(f) are flow charts of illustrative steps involved in performing an inverse continuous wavelet transform in accordance with embodiments;

FIG. 4 is a block diagram of an illustrative continuous wavelet processing system in accordance with some embodiments;

FIG. 5 shows an illustrative scalogram and input signal in accordance with some embodiments;

FIG. 6 shows another illustrative scalogram and input signal in accordance with some embodiments;

FIG. 7 is a flow chart of illustrative steps for analyzing a physiological signal to determine physiological information in accordance with some embodiments;

FIG. 8 is a flow chart of illustrative steps for analyzing a physiological signal to determine confidence information in accordance with some embodiments; and

FIG. 9 is a flow chart of illustrative steps for analyzing and processing information from a scalogram in accordance with some embodiments.

### DETAILED DESCRIPTION

An oximeter is a medical device that may determine the oxygen saturation of the blood. One common type of oximeter is a pulse oximeter, which may indirectly measure the oxygen saturation of a patient's blood (as opposed to measuring oxygen saturation directly by analyzing a blood sample taken from the patient) and changes in blood volume in the skin. Ancillary to the blood oxygen saturation measurement, pulse oximeters may also be used to measure the pulse rate of the patient. Pulse oximeters typically measure and display various blood flow characteristics including, but not limited to, the oxygen saturation of hemoglobin in arterial blood.

An oximeter may include a light sensor that is placed at a site on a patient, typically a fingertip, toe, forehead or earlobe, or in the case of a neonate, across a foot. The oximeter may pass light using a light source through blood perfused tissue and photoelectrically sense the absorption of light in the tissue. For example, the oximeter may measure the intensity of light that is received at the light sensor as a function of time. A signal representing light intensity versus time or a mathematical manipulation of this signal (e.g., a scaled version thereof, a log taken thereof, a scaled version of a log taken thereof, etc.) may be referred to as the photoplethysmograph (PPG) signal. In addition, the term “PPG signal,” as used herein, may also refer to an absorption signal (i.e., representing the amount of light absorbed by the tissue) or any suitable mathematical manipulation thereof. The light intensity or the amount of light absorbed may then be used to calculate the amount of the blood constituent (e.g., oxyhemoglobin) being measured as well as the pulse rate and when each individual pulse occurs.

The light passed through the tissue is selected to be of one or more wavelengths that are absorbed by the blood in an amount representative of the amount of the blood constituent present in the blood. The amount of light passed through the tissue varies in accordance with the changing amount of blood constituent in the tissue and the related light absorption. Red and infrared wavelengths may be used because it has been observed that highly oxygenated blood will absorb relatively less red light and more infrared light than blood with a lower oxygen saturation. By comparing the intensities of two wavelengths at different points in the pulse cycle, it is possible to estimate the blood oxygen saturation of hemoglobin in arterial blood.

When the measured blood parameter is the oxygen saturation of hemoglobin, a convenient starting point assumes a saturation calculation based on Lambert-Beer's law. The following notation will be used herein:

I(λ,t)=Iₒ(λ)exp(−(sβₒ(λ)+(1−s)βᵣ(λ))l(t)) (1)

where:
λ=wavelength;
t=time;
I=intensity of light detected;
Iₒ=intensity of light transmitted;
s=oxygen saturation;
βₒ, βᵣ=empirically derived absorption coefficients; and
l(t)=a combination of concentration and path length from emitter to detector as a function of time.

The traditional approach measures light absorption at two wavelengths (e.g., red and infrared (IR)), and then calculates saturation by solving for the “ratio of ratios” as follows.

1. First, the natural logarithm of (1) is taken (“log” will be used to represent the natural logarithm) for IR and Red

log I=log Iₒ−(sβₒ+(1−s)βᵣ)l (2)

2. (2) is then differentiated with respect to time

$$\frac{d log I}{d t} = - ( s {β}_{o} + ( 1 - s ) {β}_{r} ) \frac{d l}{d t} \qquad ( 3 )$$

3. Red (3) is divided by IR (3)

$$\frac{\frac{d log I ( {λ}_{R} )}{d t}}{\frac{d log I ( {λ}_{IR} )}{d t}} = \frac{s {β}_{o} ( {λ}_{R} ) + ( 1 - s ) {β}_{r} ( {λ}_{R} )}{s {β}_{o} ( {λ}_{IR} ) + ( 1 - s ) {β}_{r} ( {λ}_{IR} )} \qquad ( 4 )$$

### 4. Solving for s

$$s = \frac{\frac{d log I ( {λ}_{IR} )}{d t} {β}_{r} ( {λ}_{R} ) - \frac{d log I ( {λ}_{R} )}{d t} {β}_{r} ( {λ}_{IR} )}{\frac{d log I ( {λ}_{R} )}{d t} ( {β}_{o} ( {λ}_{IR} ) - {β}_{r} ( {λ}_{IR} ) ) - \frac{d log I ( {λ}_{IR} )}{d t} ( {β}_{o} ( {λ}_{R} ) - {β}_{r} ( {λ}_{R} ) )}$$

Note in discrete time

$$\frac{d log I ( λ , t )}{d t} ≃ log I ( λ , {t}_{2} ) - log I ( λ , {t}_{1} )$$

### Using log A−log B=log A/B,

$$\frac{d log I ( λ , t )}{d t} ≃ log ( \frac{I ( {t}_{2} , λ )}{I ( {t}_{1} , λ )} )$$

So, (4) can be rewritten as

$$\frac{\frac{d log I ( {λ}_{R} )}{d t}}{\frac{d log I ( {λ}_{IR} )}{d t}} ≃ \frac{log ( \frac{I ( {t}_{1} , {λ}_{R} )}{I ( {t}_{2} , {λ}_{R} )} )}{log ( \frac{I ( {t}_{1} , {λ}_{IR} )}{I ( {t}_{2} , {λ}_{IR} )} )} = R \qquad ( 5 )$$

where R represents the “ratio of ratios.” Solving (4) for s using (5) gives

$$s = \frac{{β}_{r} ( {λ}_{R} ) - R {β}_{r} ( {λ}_{IR} )}{R ( {β}_{o} ( {λ}_{IR} ) - {β}_{r} ( {λ}_{IR} ) ) - {β}_{o} ( {λ}_{R} ) + {β}_{r} ( {λ}_{R} )} .$$

From (5), R can be calculated using two points (e.g., PPG maximum and minimum), or a family of points. One method using a family of points uses a modified version of (5). Using the relationship

$$\frac{d log I}{d t} = \frac{d I / d t}{I} \qquad ( 6 )$$

now (5) becomes

$$\frac{\frac{d log I ( {λ}_{R} )}{d t}}{\frac{d log I ( {λ}_{IR} )}{d t}} ≃ \frac{\frac{I ( {t}_{2} , {λ}_{R } ) - I ( {t}_{1} , {λ}_{R} )}{I ( {t}_{1} , {λ}_{R} )}}{\frac{I ( {t}_{2} , {λ}_{IR} ) - I ( {t}_{1} , {λ}_{IR} )}{I ( {t}_{1} , {λ}_{IR} )}} = \frac{[ I ( {t}_{2} , {λ}_{R } ) - I ( {t}_{1} , {λ}_{R} ) ] I ( {t}_{1} , {λ}_{IR} )}{[ I ( {t}_{2} , {λ}_{IR } ) - I ( {t}_{1} , {λ}_{IR} ) ] I ( {t}_{1} , {λ}_{R} )} = R \qquad ( 7 )$$

which defines a cluster of points whose slope of y versus x will give R where

x(t)=[I(t₂,λ_{IR})−I(t₁,λ_{IR})]I(t₁,λ_{R})

y(t)==[I(t₂,λ_{R})−I(t₁,λ_{R})]I(t₁,λ_{IR})

y(t)=Rx(t) (8)

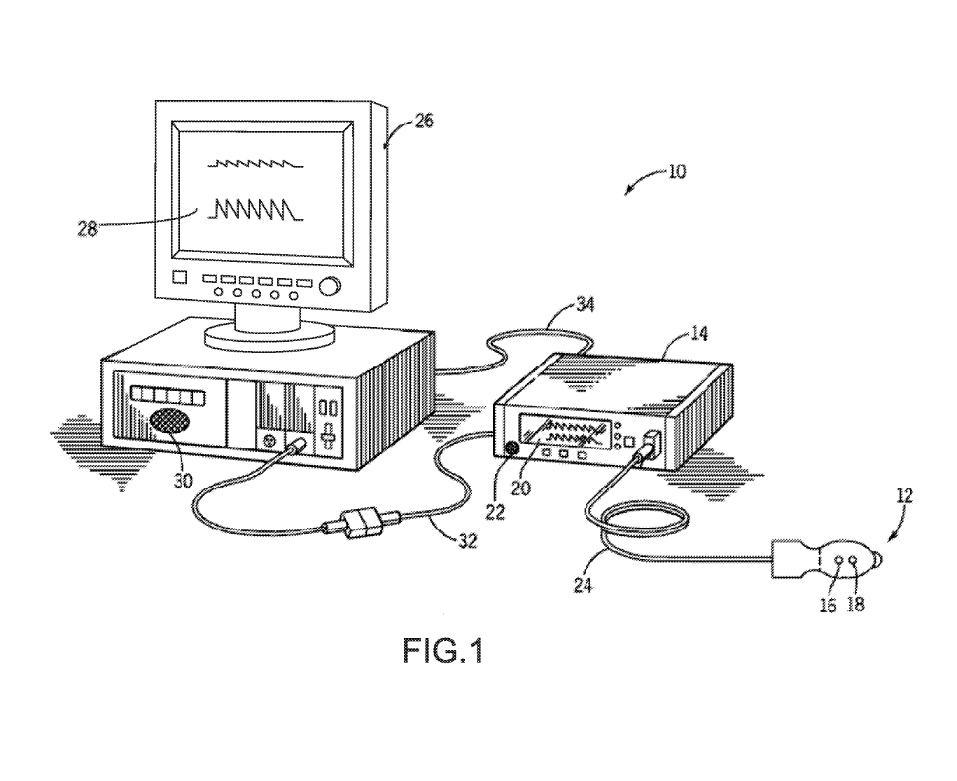

FIG. 1 is a perspective view of an embodiment of a pulse oximetry system 10. System 10 may include a sensor 12 and a pulse oximetry monitor 14. Sensor 12 may include an emitter 16 for emitting light at two or more wavelengths into a patient's tissue. A detector 18 may also be provided in sensor 12 for detecting the light originally from emitter 16 that emanates from the patient's tissue after passing through the tissue.

According to another embodiment and as will be described, system 10 may include a plurality of sensors forming a sensor array in lieu of single sensor 12. Each of the sensors of the sensor array may be a complementary metal oxide semiconductor (CMOS) sensor. Alternatively, each sensor of the array may be charged coupled device (CCD) sensor. In another embodiment, the sensor array may be made up of a combination of CMOS and CCD sensors. The CCD sensor may comprise a photoactive region and a transmission region for receiving and transmitting data whereas the CMOS sensor may be made up of an integrated circuit having an array of pixel sensors. Each pixel may have a photodetector and an active amplifier.

According to an embodiment, emitter 16 and detector 18 may be on opposite sides of a digit such as a finger or toe, in which case the light that is emanating from the tissue has passed completely through the digit. In an embodiment, emitter 16 and detector 18 may be arranged so that light from emitter 16 penetrates the tissue and is reflected by the tissue into detector 18, such as a sensor designed to obtain pulse oximetry data from a patient's forehead.

In an embodiment, the sensor or sensor array may be connected to and draw its power from monitor 14 as shown. In another embodiment, the sensor may be wirelessly connected to monitor 14 and include its own battery or similar power supply (not shown). Monitor 14 may be configured to calculate physiological parameters based at least in part on data received from sensor 12 relating to light emission and detection. In an alternative embodiment, the calculations may be performed on the monitoring device itself and the result of the oximetry reading may be passed to monitor 14. Further, monitor 14 may include a display 20 configured to display the physiological parameters or other information about the system. In the embodiment shown, monitor 14 may also include a speaker 22 to provide an audible sound that may be used in various other embodiments, such as for example, sounding an audible alarm in the event that a patient's physiological parameters are not within a predefined normal range.

In an embodiment, sensor 12, or the sensor array, may be communicatively coupled to monitor 14 via a cable 24. However, in other embodiments, a wireless transmission device (not shown) or the like may be used instead of or in addition to cable 24.

In the illustrated embodiment, pulse oximetry system 10 may also include a multi-parameter patient monitor 26. The monitor may be cathode ray tube type, a flat panel display (as shown) such as a liquid crystal display (LCD) or a plasma display, or any other type of monitor now known or later developed. Multi-parameter patient monitor 26 may be configured to calculate physiological parameters and to provide a display 28 for information from monitor 14 and from other medical monitoring devices or systems (not shown). For example, multi-parameter patient monitor 26 may be configured to display an estimate of a patient's blood oxygen saturation generated by pulse oximetry monitor 14 (referred to as an “SpO₂” measurement), pulse rate information from monitor 14 and blood pressure from a blood pressure monitor (not shown) on display 28.

Monitor 14 may be communicatively coupled to multi-parameter patient monitor 26 via a cable 32 or 34 that is coupled to a sensor input port or a digital communications port, respectively and/or may communicate wirelessly (not shown). In addition, monitor 14 and/or multi-parameter patient monitor 26 may be coupled to a network to enable the sharing of information with servers or other workstations (not shown). Monitor 14 may be powered by a battery (not shown) or by a conventional power source such as a wall outlet.

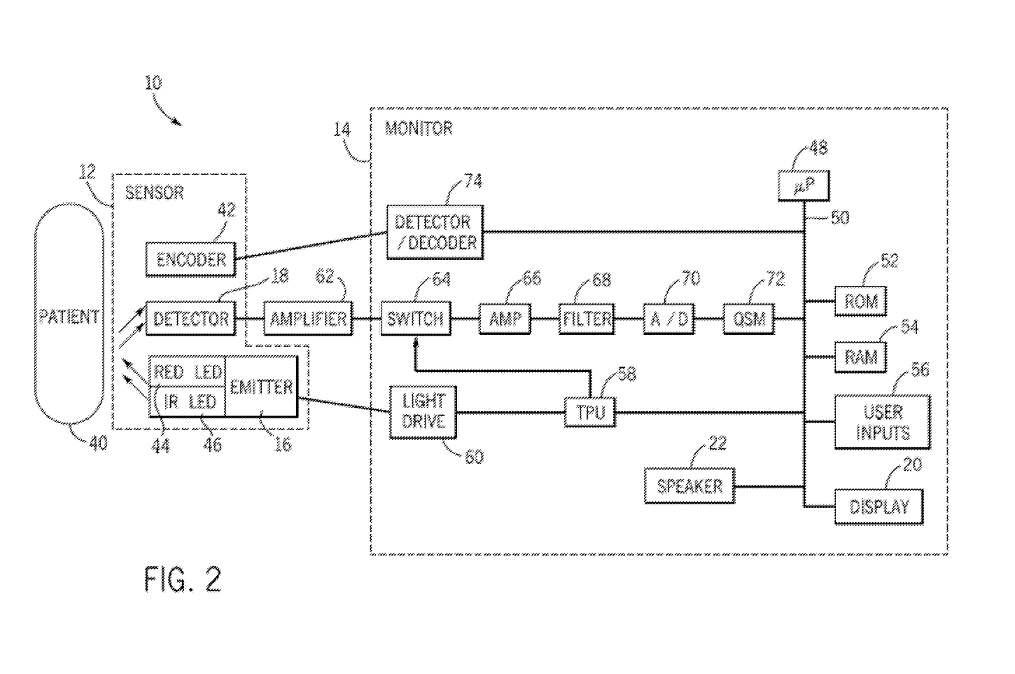

FIG. 2 is a block diagram of a pulse oximetry system, such as pulse oximetry system 10 of FIG. 1, which may be coupled to a patient 40 in accordance with an embodiment. Certain illustrative components of sensor 12 and monitor 14 are illustrated in FIG. 2. Sensor 12 may include emitter 16, detector 18, and encoder 42. In the embodiment shown, emitter 16 may be configured to emit at least two wavelengths of light (e.g., RED and IR) into a patient's tissue 40. Hence, emitter 16 may include a RED light emitting light source such as RED light emitting diode (LED) 44 and an IR light emitting light source such as IR LED 46 for emitting light into the patient's tissue 40 at the wavelengths used to calculate the patient's physiological parameters. In one embodiment, the RED wavelength may be between about 600 nm and about 700 nm, and the IR wavelength may be between about 800 nm and about 1000 nm. In embodiments where a sensor array is used in place of single sensor, each sensor may be configured to emit a single wavelength. For example, a first sensor emits only a RED light while a second only emits an IR light.

It will be understood that, as used herein, the term “light” may refer to energy produced by radiative sources and may include one or more of ultrasound, radio, microwave, millimeter wave, infrared, visible, ultraviolet, gamma ray or X-ray electromagnetic radiation. As used herein, light may also include any wavelength within the radio, microwave, infrared, visible, ultraviolet, or X-ray spectra, and that any suitable wavelength of electromagnetic radiation may be appropriate for use with the present techniques. Detector 18 may be chosen to be specifically sensitive to the chosen targeted energy spectrum of the emitter 16.

In an embodiment, detector 18 may be configured to detect the intensity of light at the RED and IR wavelengths. Alternatively, each sensor in the array may be configured to detect an intensity of a single wavelength. In operation, light may enter detector 18 after passing through the patient's tissue 40. Detector 18 may convert the intensity of the received light into an electrical signal. The light intensity is directly related to the absorbance and/or reflectance of light in the tissue 40. That is, when more light at a certain wavelength is absorbed or reflected, less light of that wavelength is received from the tissue by the detector 18. After converting the received light to an electrical signal, detector 18 may send the signal to monitor 14, where physiological parameters may be calculated based on the absorption of the RED and IR wavelengths in the patient's tissue 40.

In an embodiment, encoder 42 may contain information about sensor 12, such as what type of sensor it is (e.g., whether the sensor is intended for placement on a forehead or digit) and the wavelengths of light emitted by emitter 16. This information may be used by monitor 14 to select appropriate algorithms, lookup tables and/or calibration coefficients stored in monitor 14 for calculating the patient's physiological parameters.

Encoder 42 may contain information specific to patient 40, such as, for example, the patient's age, weight, and diagnosis. This information may allow monitor 14 to determine, for example, patient-specific threshold ranges in which the patient's physiological parameter measurements should fall and to enable or disable additional physiological parameter algorithms. Encoder 42 may, for instance, be a coded resistor which stores values corresponding to the type of sensor 12 or the type of each sensor in the sensor array, the wavelengths of light emitted by emitter 16 on each sensor of the sensor array, and/or the patient's characteristics. In another embodiment, encoder 42 may include a memory on which one or more of the following information may be stored for communication to monitor 14: the type of the sensor 12; the wavelengths of light emitted by emitter 16; the particular wavelength each sensor in the sensor array is monitoring; a signal threshold for each sensor in the sensor array; any other suitable information; or any combination thereof.

In an embodiment, signals from detector 18 and encoder 42 may be transmitted to monitor 14. In the embodiment shown, monitor 14 may include a general-purpose microprocessor 48 connected to an internal bus 50. Microprocessor 48 may be adapted to execute software, which may include an operating system and one or more applications, as part of performing the functions described herein. Also connected to bus 50 may be a read-only memory (ROM) 52, a random access memory (RAM) 54, user inputs 56, display 20, and speaker 22.

RAM 54 and ROM 52 are illustrated by way of example, and not limitation. Any suitable computer-readable media may be used in the system for data storage. Computer-readable media are capable of storing information that can be interpreted by microprocessor 48. This information may be data or may take the form of computer-executable instructions, such as software applications, that cause the microprocessor to perform certain functions and/or computer-implemented methods. Depending on the embodiment, such computer-readable media may include computer storage media and communication media. Computer storage media may include volatile and non-volatile, removable and non-removable media implemented in any method or technology for storage of information such as computer-readable instructions, data structures, program modules or other data. Computer storage media may include, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by components of the system.

In the embodiment shown, a time processing unit (TPU) 58 may provide timing control signals to a light drive circuitry 60, which may control when emitter 16 is illuminated and multiplexed timing for the RED LED 44 and the IR LED 46. TPU 58 may also control the gating-in of signals from detector 18 through an amplifier 62 and a switching circuit 64. These signals are sampled at the proper time, depending upon which light source is illuminated. The received signal from detector 18 may be passed through an amplifier 66, a low pass filter 68, and an analog-to-digital converter 70. The digital data may then be stored in a queued serial module (QSM) 72 (or buffer) for later downloading to RAM 54 as QSM 72 fills up. In one embodiment, there may be multiple separate parallel paths having amplifier 66, filter 68, and A/D converter 70 for multiple light wavelengths or spectra received.

In an embodiment, microprocessor 48 may determine the patient's physiological parameters, such as SpO₂ and pulse rate, using various algorithms and/or look-up tables based on the value of the received signals and/or data corresponding to the light received by detector 18. In an embodiment, microprocessor 48 may be used for signal processing. For example, microprocessor 48 may calculate an archetype transform using a weighted averaging scheme. Signals corresponding to information about patient 40, and particularly about the intensity of light emanating from a patient's tissue over time, may be transmitted from encoder 42 to a decoder 74. These signals may include, for example, encoded information relating to patient characteristics. Decoder 74 may translate these signals to enable the microprocessor to determine the thresholds based on algorithms or look-up tables stored in ROM 52. User inputs 56 may be used to enter information about the patient, such as age, weight, height, diagnosis, medications, treatments, and so forth. In an embodiment, display 20 may exhibit a list of values which may generally apply to the patient, such as, for example, age ranges or medication families, which the user may select using user inputs 56.

The optical signal through the tissue can be degraded by noise, among other sources. One source of noise is ambient light that reaches the light detector. Another source of noise is electromagnetic coupling from other electronic instruments. Movement of the patient also introduces noise and affects the signal. For example, the contact between the detector and the skin, or the emitter and the skin, can be temporarily disrupted when movement causes either to move away from the skin. In addition, because blood is a fluid, it responds differently than the surrounding tissue to inertial effects, thus resulting in momentary changes in volume at the point to which the oximeter probe is attached.

Noise (e.g., from patient movement) can degrade a pulse oximetry signal relied upon by a physician, without the physician's awareness. This is especially true if the monitoring of the patient is remote, the motion is too small to be observed, or the doctor is watching the instrument or other parts of the patient, and not the sensor site. Processing pulse oximetry (i.e., PPG) signals may involve operations that reduce the amount of noise present in the signals or otherwise identify noise components in order to prevent them from affecting measurements of physiological parameters derived from the PPG signals.

It will be understood that the present disclosure is applicable to any suitable signals and that PPG signals are used merely for illustrative purposes. Those skilled in the art will recognize that the present disclosure has wide applicability to other signals including, but not limited to other biosignals (e.g., electrocardiogram, electroencephalogram, electrogastrogram, electromyogram, heart rate signals, pathological sounds, ultrasound, or any other suitable biosignal), dynamic signals, non-destructive testing signals, condition monitoring signals, fluid signals, geophysical signals, astronomical signals, electrical signals, financial signals including financial indices, sound and speech signals, chemical signals, meteorological signals including climate signals, and/or any other suitable signal, and/or any combination thereof.

In one embodiment, a PPG signal may be transformed using a continuous wavelet transform. Information derived from the transform of the PPG signal (i.e., in wavelet space) may be used to provide measurements of one or more physiological parameters.

The continuous wavelet transform of a signal x(t) in accordance with the present disclosure may be defined as

$$T ( a , b ) = \frac{1}{\sqrt{a}} {\int }_{- ∞}^{+ ∞} x ( t ) {ψ}^{*} ( \frac{t - b}{a} ) d t \qquad ( 9 )$$

where ψ*(t) is the complex conjugate of the wavelet function ψ(t), a is the dilation parameter of the wavelet and b is the location parameter of the wavelet. The transform given by equation (9) may be used to construct a representation of a signal on a transform surface. The transform may be regarded as a time-scale representation. Wavelets are composed of a range of frequencies, one of which may be denoted as the characteristic frequency of the wavelet, where the characteristic frequency associated with the wavelet is inversely proportional to the scale a. One example of a characteristic frequency is the dominant frequency. Each scale of a particular wavelet may have a different characteristic frequency. The underlying mathematical detail required for the implementation within a time-scale can be found, for example, in Paul S. Addison, The Illustrated Wavelet Transform Handbook (Taylor & Francis Group 2002), which is hereby incorporated by reference herein in its entirety.

The continuous wavelet transform decomposes a signal using wavelets, which are generally highly localized in time. The continuous wavelet transform may provide a higher resolution relative to discrete transforms, thus providing the ability to garner more information from signals than typical frequency transforms such as Fourier transforms (or any other spectral techniques) or discrete wavelet transforms. Continuous wavelet transforms allow for the use of a range of wavelets with scales spanning the scales of interest of a signal such that small scale signal components correlate well with the smaller scale wavelets and thus manifest at high energies at smaller scales in the transform. Likewise, large scale signal components correlate well with the larger scale wavelets and thus manifest at high energies at larger scales in the transform. Thus, components at different scales may be separated and extracted in the wavelet transform domain. Moreover, the use of a continuous range of wavelets in scale and time position allows for a higher resolution transform than is possible relative to discrete techniques.

In addition, transforms and operations that convert a signal or any other type of data into a spectral (i.e., frequency) domain necessarily create a series of frequency transform values in a two-dimensional coordinate system where the two dimensions may be frequency and, for example, amplitude. For example, any type of Fourier transform would generate such a two-dimensional spectrum. In contrast, wavelet transforms, such as continuous wavelet transforms, are required to be defined in a three-dimensional coordinate system and generate a surface with dimensions of time, scale and, for example, amplitude. Hence, operations performed in a spectral domain cannot be performed in the wavelet domain; instead the wavelet surface must be transformed into a spectrum (i.e., by performing an inverse wavelet transform to convert the wavelet surface into the time domain and then performing a spectral transform from the time domain). Conversely, operations performed in the wavelet domain cannot be performed in the spectral domain; instead a spectrum must first be transformed into a wavelet surface (i.e., by performing an inverse spectral transform to convert the spectral domain into the time domain and then performing a wavelet transform from the time domain). Nor does a cross-section of the three-dimensional wavelet surface along, for example, a particular point in time equate to a frequency spectrum upon which spectral-based techniques may be used. At least because wavelet space includes a time dimension, spectral techniques and wavelet techniques are not interchangeable. It will be understood that converting a system that relies on spectral domain processing to one that relies on wavelet space processing would require significant and fundamental modifications to the system in order to accommodate the wavelet space processing (e.g., to derive a representative energy value for a signal or part of a signal requires integrating twice, across time and scale, in the wavelet domain while, conversely, one integration across frequency is required to derive a representative energy value from a spectral domain). As a further example, to reconstruct a temporal signal requires integrating twice, across time and scale, in the wavelet domain while, conversely, one integration across frequency is required to derive a temporal signal from a spectral domain. It is well known in the art that, in addition to or as an alternative to amplitude, parameters such as energy density, modulus, phase, among others may all be generated using such transforms and that these parameters have distinctly different contexts and meanings when defined in a two-dimensional frequency coordinate system rather than a three-dimensional wavelet coordinate system. For example, the phase of a Fourier system is calculated with respect to a single origin for all frequencies while the phase for a wavelet system is unfolded into two dimensions with respect to a wavelet's location (often in time) and scale.

The energy density function of the wavelet transform, the scalogram, is defined as

S(a,b)=|T(a,b)|² (10)

where ‘∥’ is the modulus operator. The scalogram may be rescaled for useful purposes. One common rescaling is defined as

$${S}_{R} ( a , b ) = \frac{\vert T ( a , b ) {\vert}^{2}}{a} \qquad ( 11 )$$

and is useful for defining ridges in wavelet space when, for example, the Morlet wavelet is used. Ridges are defined as the locus of points of local maxima in the plane. Any reasonable definition of a ridge may be employed in the method. Also included as a definition of a ridge herein are paths displaced from the locus of the local maxima. A ridge associated with only the locus of points of local maxima in the plane are labeled a “maxima ridge”.

For implementations requiring fast numerical computation, the wavelet transform may be expressed as an approximation using Fourier transforms. Pursuant to the convolution theorem, because the wavelet transform is the cross-correlation of the signal with the wavelet function, the wavelet transform may be approximated in terms of an inverse FFT of the product of the Fourier transform of the signal and the Fourier transform of the wavelet for each required a scale and then multiplying the result by \sqrt{a}.

In the discussion of the technology which follows herein, the “scalogram” may be taken to include all suitable forms of rescaling including, but not limited to, the original unscaled wavelet representation, linear rescaling, any power of the modulus of the wavelet transform, or any other suitable rescaling. In addition, for purposes of clarity and conciseness, the term “scalogram” shall be taken to mean the wavelet transform, T(a,b) itself, or any part thereof. For example, the real part of the wavelet transform, the imaginary part of the wavelet transform, the phase of the wavelet transform, any other suitable part of the wavelet transform, or any combination thereof is intended to be conveyed by the term “scalogram”.

A scale, which may be interpreted as a representative temporal period, may be converted to a characteristic frequency of the wavelet function. The characteristic frequency associated with a wavelet of arbitrary a scale is given by

$$f + \frac{fc}{a} \qquad ( 12 )$$

where f_{c}, the characteristic frequency of the mother wavelet (i.e., at a=1), becomes a scaling constant and f is the representative or characteristic frequency for the wavelet at arbitrary scale a.

Any suitable wavelet function may be used in connection with the present disclosure. One of the most commonly used complex wavelets, the Morlet wavelet, is defined as:

ψ(t)=π^{-1/4}(e^{i2πf}^{₀}^{t}−e^{-(2πf}^{₀}⁾^{²}^{/2})e^{-t}^{²}^{/2} (13)

where f₀ is the central frequency of the mother wavelet. The second term in the parenthesis is known as the correction term, as it corrects for the non-zero mean of the complex sinusoid within the Gaussian window. In practice, it becomes negligible for values of f₀>>0 and can be ignored, in which case, the Morlet wavelet can be written in a simpler form as

$$ψ ( t ) = \frac{1}{{π}^{1 / 4}} {e}^{i 2 π {f}_{0} t} {e}^{- {t}^{2} / 2} \qquad ( 14 )$$

This wavelet is a complex wave within a scaled Gaussian envelope. While both definitions of the Morlet wavelet are included herein, the function of equation (14) is not strictly a wavelet as it has a non-zero mean (i.e., the zero frequency term of its corresponding energy spectrum is non-zero). However, it will be recognized by those skilled in the art that equation (14) may be used in practice with f₀>>0 with minimal error and is included (as well as other similar near wavelet functions) in the definition of a wavelet herein. A more detailed overview of the underlying wavelet theory, including the definition of a wavelet function, can be found in the general literature. Discussed herein is how wavelet transform features may be extracted from the wavelet decomposition of signals. For example, wavelet decomposition of PPG signals may be used to provide clinically useful information within a medical device.

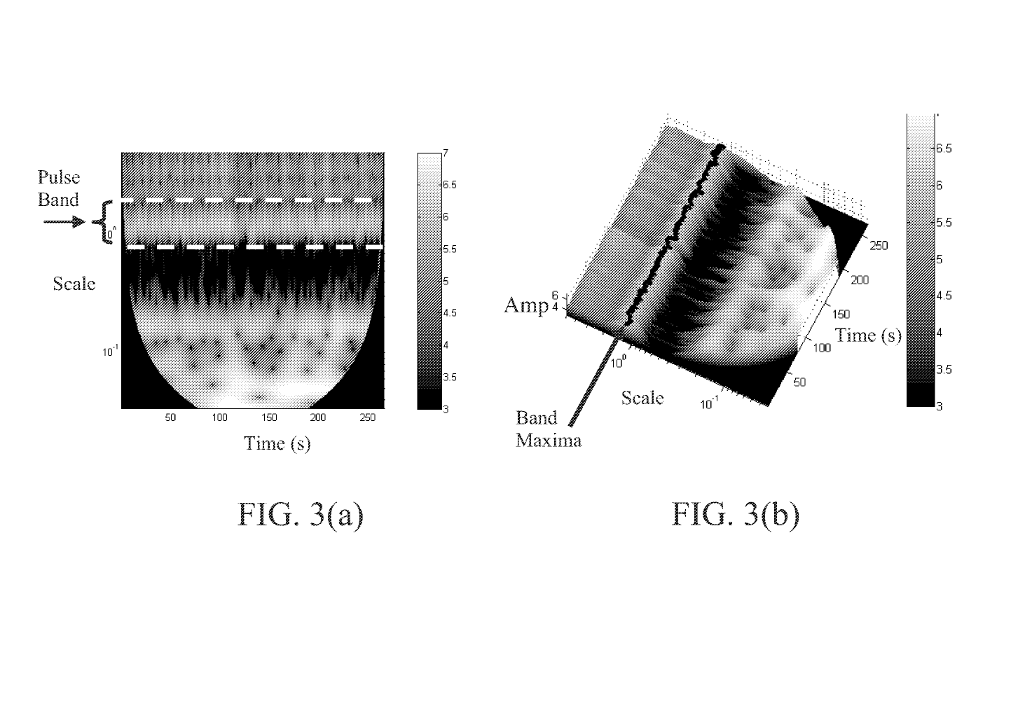

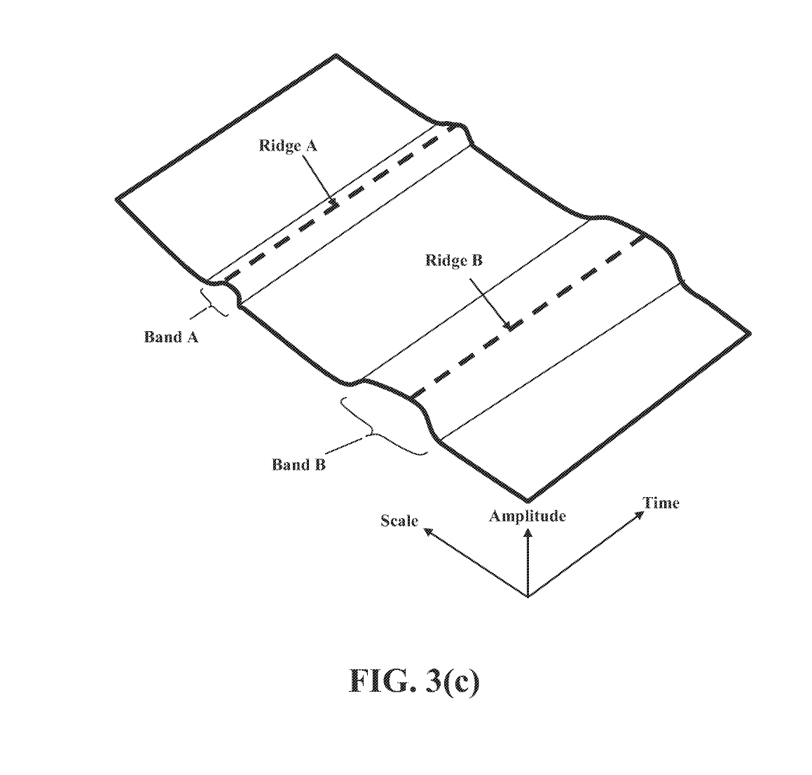

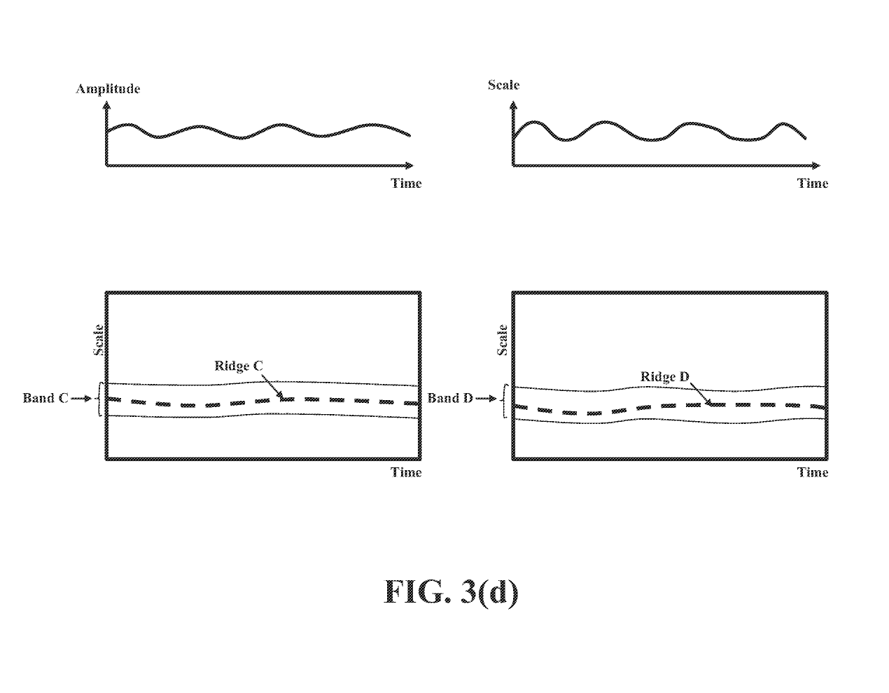

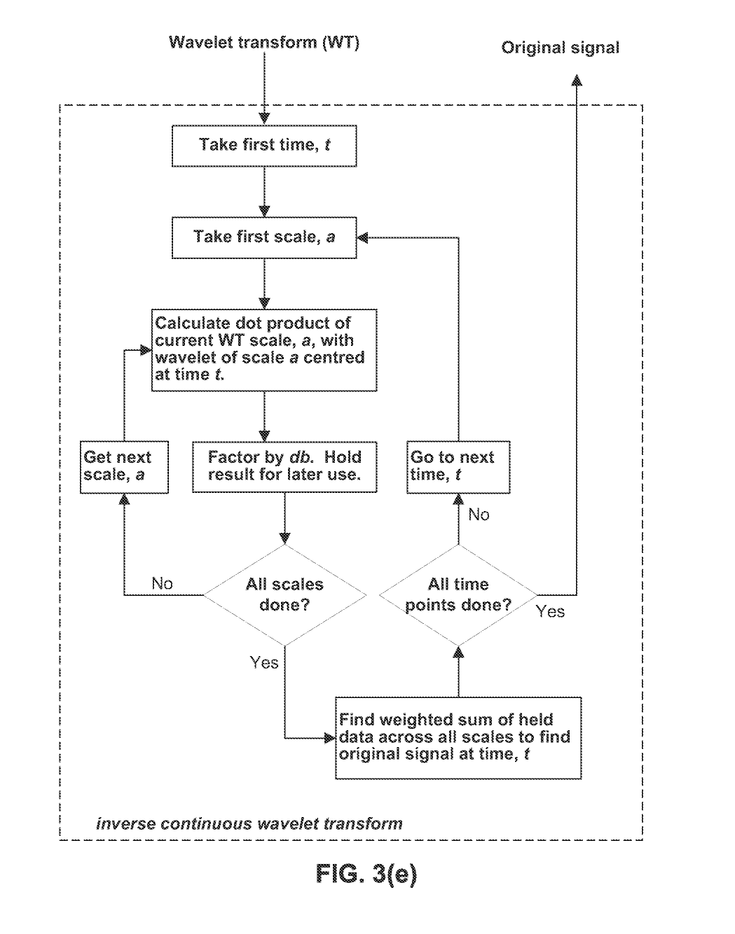

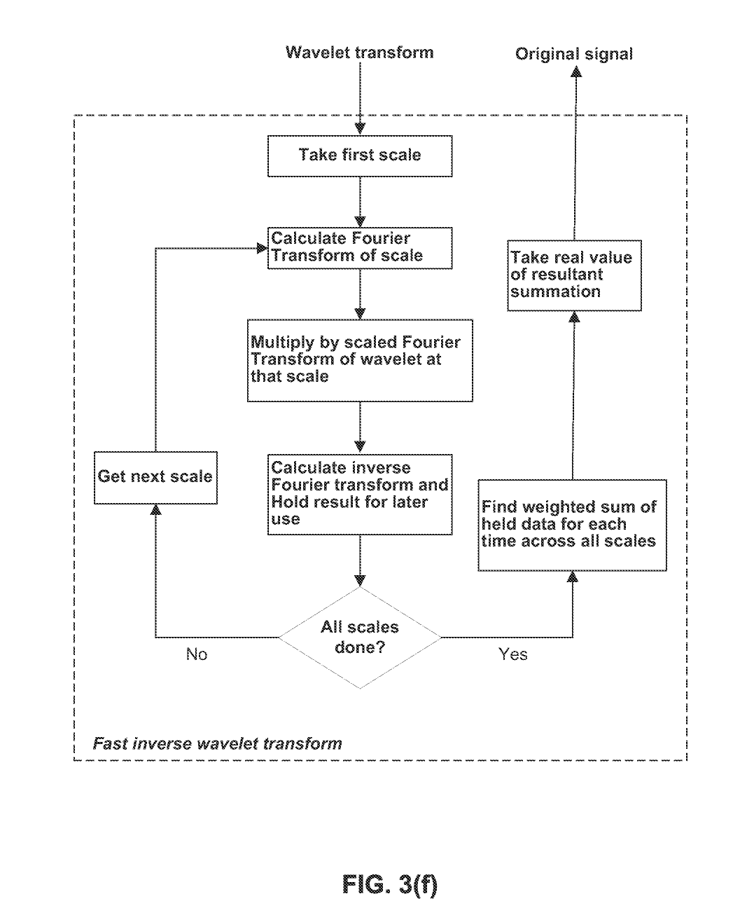

Pertinent repeating features in a signal give rise to a time-scale band in wavelet space or a rescaled wavelet space. For example, the pulse component of a PPG signal produces a dominant band in wavelet space at or around the pulse frequency. FIGS. 3(a) and (b) show two views of an illustrative scalogram derived from a PPG signal, according to an embodiment. The figures show an example of the band caused by the pulse component in such a signal. The pulse band is located between the dashed lines in the plot of FIG. 3(a). The band is formed from a series of dominant coalescing features across the scalogram. This can be clearly seen as a raised band across the transform surface in FIG. 3(b) located within the region of scales indicated by the arrow in the plot (corresponding to 60 beats per minute). The maxima of this band with respect to scale is the ridge. The locus of the ridge is shown as a black curve on top of the band in FIG. 3(b). By employing a suitable rescaling of the scalogram, such as that given in equation (11), the ridges found in wavelet space may be related to the instantaneous frequency of the signal. In this way, the pulse rate may be obtained from the PPG signal. Instead of rescaling the scalogram, a suitable predefined relationship between the scale obtained from the ridge on the wavelet surface and the actual pulse rate may also be used to determine the pulse rate.

By mapping the time-scale coordinates of the pulse ridge onto the wavelet phase information gained through the wavelet transform, individual pulses may be captured. In this way, both times between individual pulses and the timing of components within each pulse may be monitored and used to detect heart beat anomalies, measure arterial system compliance, or perform any other suitable calculations or diagnostics. Alternative definitions of a ridge may be employed. Alternative relationships between the ridge and the pulse frequency of occurrence may be employed.

As discussed above, pertinent repeating features in the signal give rise to a time-scale band in wavelet space or a rescaled wavelet space. For a periodic signal, this band remains at a constant scale in the time-scale plane. For many real signals, especially biological signals, the band may be non-stationary; varying in scale, amplitude, or both over time. FIG. 3(c) shows an illustrative schematic of a wavelet transform of a signal containing two pertinent components leading to two bands in the transform space, according to an embodiment. These bands are labeled band A and band B on the three-dimensional schematic of the wavelet surface. In this embodiment, the band ridge is defined as the locus of the peak values of these bands with respect to scale. For purposes of discussion, it may be assumed that band B contains the signal information of interest. This will be referred to as the “primary band”. In addition, it may be assumed that the system from which the signal originates, and from which the transform is subsequently derived, exhibits some form of coupling between the signal components in band A and band B. When noise or other erroneous features are present in the signal with similar spectral characteristics of the features of band B then the information within band B can become ambiguous (i.e., obscured, fragmented or missing). In this case, the ridge of band A may be followed in wavelet space and extracted either as an amplitude signal or a scale signal which will be referred to as the “ridge amplitude perturbation” (RAP) signal and the “ridge scale perturbation” (RSP) signal, respectively. The RAP and RSP signals may be extracted by projecting the ridge onto the time-amplitude or time-scale planes, respectively. The top plots of FIG. 3(d) show a schematic of the RAP and RSP signals associated with ridge A in FIG. 3(c). Below these RAP and RSP signals are schematics of a further wavelet decomposition of these newly derived signals. This secondary wavelet decomposition allows for information in the region of band B in FIG. 3(c) to be made available as band C and band D. The ridges of bands C and D may serve as instantaneous time-scale characteristic measures of the signal components causing bands C and D. This technique, which will be referred to herein as secondary wavelet feature decoupling (SWFD), may allow information concerning the nature of the signal components associated with the underlying physical process causing the primary band B (FIG. 3(c)) to be extracted when band B itself is obscured in the presence of noise or other erroneous signal features.

In some instances, an inverse continuous wavelet transform may be desired, such as when modifications to a scalogram (or modifications to the coefficients of a transformed signal) have been made in order to, for example, remove artifacts. In one embodiment, there is an inverse continuous wavelet transform which allows the original signal to be recovered from its wavelet transform by integrating over all scales and locations, a and b:

$$x ( t ) = \frac{1}{{C}_{g}} {\int }_{- ∞}^{∞} {\int }_{0}^{∞} T ( a , b ) \frac{1}{\sqrt{a}} ψ ( \frac{t - b}{a} ) \frac{d a d b}{{a}^{2}} \qquad ( 15 )$$

which may also be written as:

$$x ( t ) = \frac{1}{{C}_{g}} {\int }_{- ∞}^{∞} {\int }_{0}^{∞} T ( a , b ) {ψ}_{a , b} ( t ) \frac{d a d b}{{a}^{2}} \qquad ( 16 )$$

where C_{g} is a scalar value known as the admissibility constant. It is wavelet type dependent and may be calculated from:

$${C}_{g} = {\int }_{0}^{∞} \frac{\vert \hat{ψ} ( f ) {\vert}^{2}}{f} d f \qquad ( 17 )$$

FIG. 3(e) is a flow chart of illustrative steps that may be taken to perform an inverse continuous wavelet transform in accordance with the above discussion. An approximation to the inverse transform may be made by considering equation (15) to be a series of convolutions across scales. It shall be understood that there is no complex conjugate here, unlike for the cross correlations of the forward transform. As well as integrating over all of a and b for each time t, this equation may also take advantage of the convolution theorem which allows the inverse wavelet transform to be executed using a series of multiplications. FIG. 3(f) is a flow chart of illustrative steps that may be taken to perform an approximation of an inverse continuous wavelet transform. It will be understood that any other suitable technique for performing an inverse continuous wavelet transform may be used in accordance with the present disclosure.

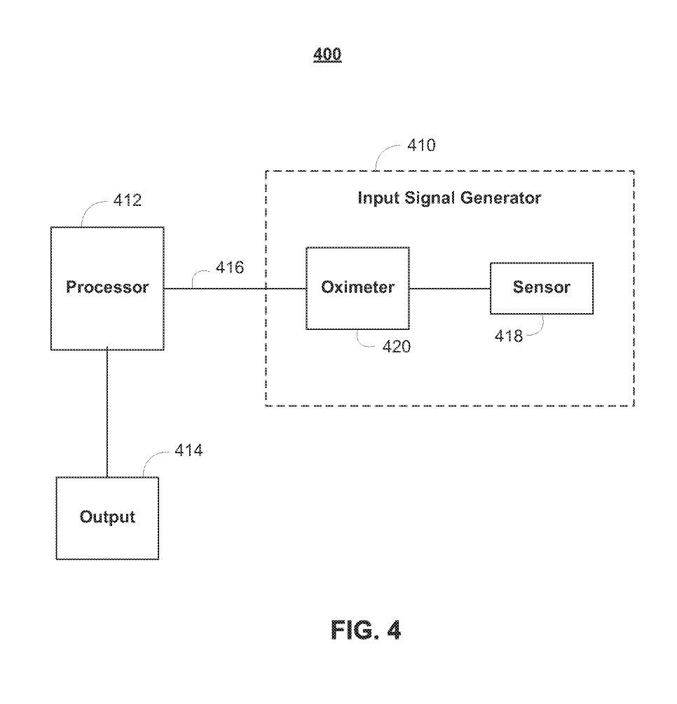

FIG. 4 is an illustrative continuous wavelet processing system in accordance with an embodiment. In this embodiment, input signal generator 410 generates an input signal 416. As illustrated, input signal generator 410 may include oximeter 420 coupled to sensor 418, which may provide as input signal 416, a PPG signal. It will be understood that input signal generator 410 may include any suitable signal source, signal generating data, signal generating equipment, or any combination thereof to produce signal 416. Signal 416 may be any suitable signal or signals, such as, for example, biosignals (e.g., electrocardiogram, electroencephalogram, electrogastrogram, electromyogram, heart rate signals, pathological sounds, ultrasound, or any other suitable biosignal), dynamic signals, non-destructive testing signals, condition monitoring signals, fluid signals, geophysical signals, astronomical signals, electrical signals, financial signals including financial indices, sound and speech signals, chemical signals, meteorological signals including climate signals, and/or any other suitable signal, and/or any combination thereof.

In an embodiment, signal 416 may be coupled to processor 412. Processor 412 may be any suitable software, firmware, and/or hardware, and/or combinations thereof for processing signal 416. For example, processor 412 may include one or more hardware processors (e.g., integrated circuits), one or more software modules, computer-readable media such as memory, firmware, or any combination thereof. Processor 412 may, for example, be a computer or may be one or more chips (i.e., integrated circuits). Processor 412 may perform the calculations associated with the continuous wavelet transforms of the present disclosure as well as the calculations associated with any suitable interrogations of the transforms. Processor 412 may perform any suitable signal processing of signal 416 to filter signal 416, such as any suitable band-pass filtering, adaptive filtering, closed-loop filtering, and/or any other suitable filtering, and/or any combination thereof.

Processor 412 may be coupled to one or more memory devices (not shown) or incorporate one or more memory devices such as any suitable volatile memory device (e.g., RAM, registers, etc.), non-volatile memory device (e.g., ROM, EPROM, magnetic storage device, optical storage device, flash memory, etc.), or both. The memory may be used by processor 412 to, for example, store data corresponding to a continuous wavelet transform of input signal 416, such as data representing a scalogram. In one embodiment, data representing a scalogram may be stored in RAM or memory internal to processor 412 as any suitable three-dimensional data structure such as a three-dimensional array that represents the scalogram as energy levels in a time-scale plane. Any other suitable data structure may be used to store data representing a scalogram.

Processor 412 may be coupled to output 414. Output 414 may be any suitable output device such as, for example, one or more medical devices (e.g., a medical monitor that displays various physiological parameters, a medical alarm, or any other suitable medical device that either displays physiological parameters or uses the output of processor 412 as an input), one or more display devices (e.g., monitor, PDA, mobile phone, any other suitable display device, or any combination thereof), one or more audio devices, one or more memory devices (e.g., hard disk drive, flash memory, RAM, optical disk, any other suitable memory device, or any combination thereof), one or more printing devices, any other suitable output device, or any combination thereof.

It will be understood that system 400 may be incorporated into system 10 (FIGS. 1 and 2) in which, for example, input signal generator 410 may be implemented as parts of sensor 12 and monitor 14 and processor 412 may be implemented as part of monitor 14.

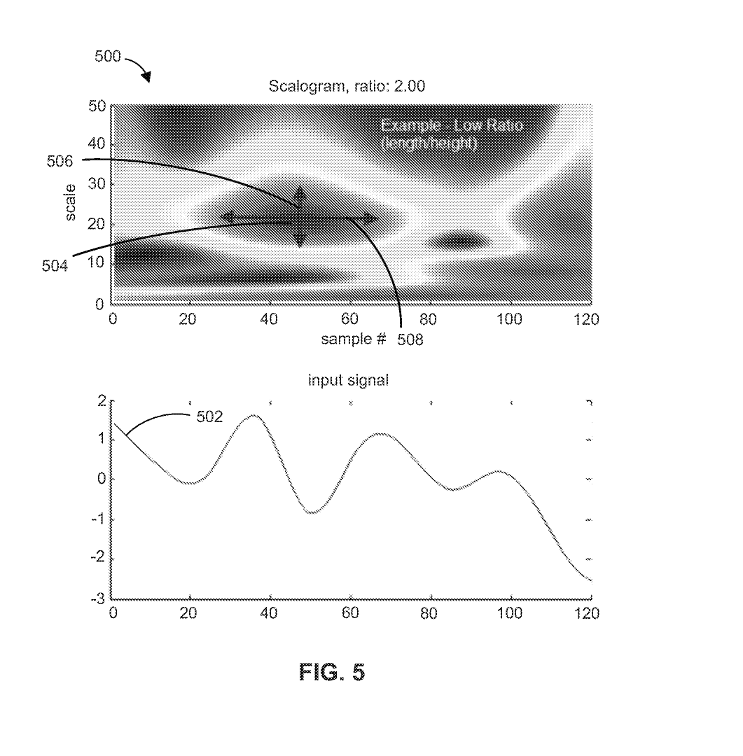

FIG. 5 shows an illustrative scalogram 500 and input signal 502 in accordance with some embodiments. Scalogram 500 may be based at least in part on a continuous wavelet transform of input signal 502. Input signal 502 may be a physiological signal, such as a plethysmograph signal, obtained from patient 40 using sensor 12 or input signal generator 410 in real time, or may be received as input signal 416. In some embodiments, input signal 502 may have been stored in ROM 52, RAM 54, and/or QSM 72 (FIG. 2) in the past and may be accessed by microprocessor 48 within monitor 14 to be processed.

Different shades of gray correspond to different levels of energy in scalogram 500. As illustrated by the various shades, energy is distributed through scalogram 500. In some embodiments, a region of interest in scalogram 500 may include a region of high energy 504. Characteristics of region 504 may be measured to quantify the periodicity of input signal 502. In some embodiments, “height” 506 of region 504 is measured along the scale axis of scalogram 500. “Length” 508 of region 504 is measured along the time axis of scalogram 500. The ratio of length 508 to height 506 may be calculated to determine information about input signal 502. In general, higher ratios may be indicative of “cleaner” signals (e.g., input signals that have a concentrated range of frequencies over a longer duration). Lower ratios may be indicative of signals that contain a wider range of frequencies and/or exhibit concentrated frequencies over shorter durations. As used herein, the term “clean signal” may refer to a signal having a relatively high signal to noise ratio and/or a signal exhibiting some expected behavior (e.g., an idealized signal). The ratio for region 504 as illustrated is relatively low, indicating a widely fluctuating input signal 502. In the case where input signal 502 is a PPG, the irregular fluctuations of input signal 502 may represent, for example, an irregular heartbeat or irregular breathing of a patient.

An ideal “clean” input signal, such as a PPG signal obtained from a healthy patient who is breathing normally and has a stable pulse, is expected to contain, in its corresponding scalogram, at least one region of high energy that has a height concentrated over a smaller range of scales. The smaller the height, the more limited the number of scales or signals represented in the scalogram. In the case of a PPG signal, a region of high energy that has a relatively long length is indicative of, for example, a consistent physiological pulse (when located in the scale range associated with pulse rate) or consistent respiration (when located in the scale range associated with breathing rate). A narrow, long region of high energy in a scalogram allows information (e.g. physiological information) to be determined from the scalogram with more confidence. For example, in the case where the input signal is a PPG signal, it may be determined with confidence from a scalogram with a narrow, long region of high energy in an appropriate range of scales that the patient is breathing steadily.

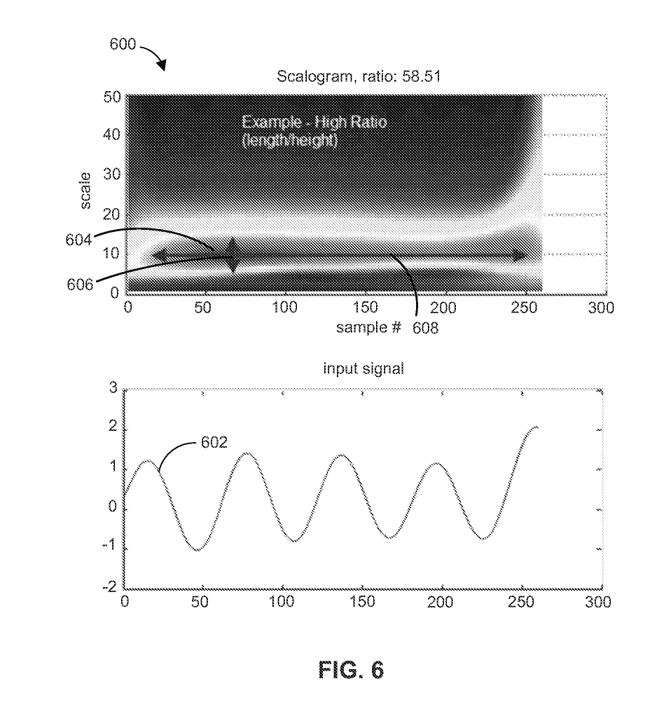

FIG. 6 shows illustrative scalogram 600 and input signal 602 in accordance with some embodiments. Scalogram 600 may be based at least in part on a continuous wavelet transform of input signal 602. Input signal 602 may be a physiological signal, such as a PPG signal, obtained from patient 40 using sensor 12 or input signal generator 410 in real time, or may be received as input signal 416. In some embodiments, input signal 602 may have been stored in ROM 52, RAM 54, and/or QSM 72 (FIG. 2) in the past and may be accessed by microprocessor 48 within monitor 14 to be processed.

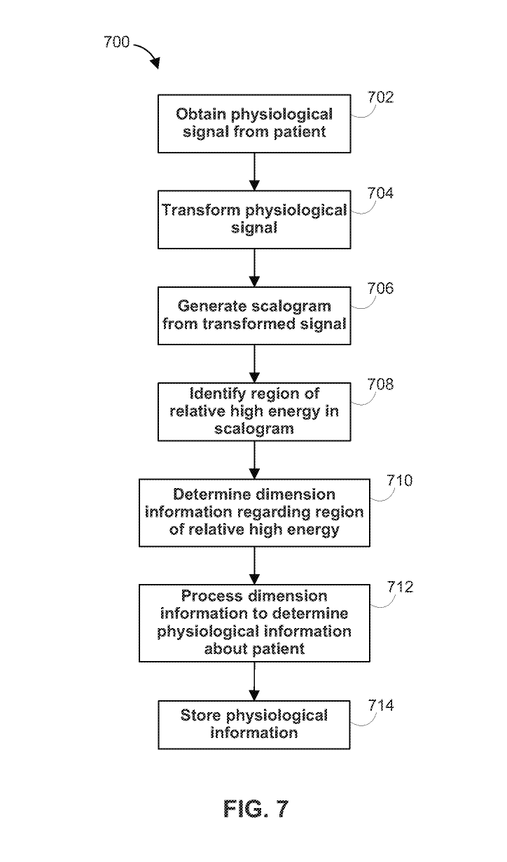

Different shades of gray correspond to different levels of energy in scalogram 600. As illustrated in scalogram 600, energy is concentrated in region 604. Characteristics of region 604 may be measured to quantify the periodicity of input signal 602. In some embodiments, “height” 606 of region 604 is measured along the scale axis of scalogram 600. “Length” 608 of region 604 is measured along the time axis of scalogram 600. The ratio of length 608 to height 606 may be calculated to determine information about input signal 602. The ratio for region 604 is relatively high, which may be indicative of a stable, periodic input signal 602. In the case where input signal 602 is a PPG signal, the ratio for region 604 may indicate, for example, that the patient has a steady heartbeat or is steadily breathing. Steps for analyzing scalograms and their relation to input signals are discussed in more detail below in relation to FIGS. 7-9.

FIG. 7 is a flow chart 700 of illustrative steps for analyzing a physiological signal to determine physiological information in accordance with some embodiments. The steps of flow chart 700 may be performed by processor 412, or may be performed by any suitable processing device communicatively coupled to monitor 14. The steps of flow chart 700 may be performed by a digital processing device, or implemented in analog hardware. It will be noted that the steps of flow chart 700 may be performed in any suitable order, and certain steps may be omitted entirely.

At step 702, a physiological signal may be obtained from a patient. The physiological signal may be obtained from patient 40 using sensor 12 or input signal generator 410 in real time, or may be received as input signal 416. In some embodiments, the physiological signal may have been stored in ROM 52, RAM 54, and/or QSM 72 (FIG. 2) in the past and may be accessed by microprocessor 48 within monitor 14 to be processed. The physiological signal may be, for example, a plethysmograph signal.

In some embodiments, the physiological signal obtained at step 702 may be transformed in step 704. A transformation may occur in conjunction with the obtaining at step 702, or after the signal is obtained at step 702. In some embodiments, processor 412 may transform the signal into a wavelet domain. This transformation may be performed by any one or more of the transformation techniques described herein, including a continuous wavelet transformation. The continuous wavelet transform function may be based at least in part on a wavelet function, as described above (e.g., Morlet, Mexican Hat, Haar, any other suitable wavelet, or any combination thereof). This transformation may be performed by any suitable processing device, such as processor 412 and/or microprocessor 48, which may each be a general-purpose computing device or a specialized processor. The transformation may also be performed by a separate, dedicated device.

In some embodiments, a scalogram may be generated in step 706 based at least in part on the transformation of the physiological signal obtained at step 702. A scalogram may be generated by any of the techniques described herein. In some embodiments, a scalogram may be based at least in part on any one or more features of a transformed signal. For example, a scalogram may represent the real part of a transformed signal, the imaginary part of a transformed signal, the modulus of a transformed signal, any other suitable feature of the transformed signal, or any combination thereof.

In some embodiments, a region of relative high energy may be identified in step 708 in the scalogram generated in step 706. For example, processor 412 or microprocessor 48 may compare the magnitudes of energies in the scalogram and identify a locus of points of local maxima of energy values. In some embodiments, the boundaries of a region of high energy may be established based at least in part on threshold magnitude values. For example, a region of high energy may be identified as all the points with an energy magnitude that exceeds a preset threshold magnitude. The threshold magnitude may be set based at least in part on historical or empirical data collected from one or more patients. In some embodiments, the threshold magnitude may be set based at least in part on one or more metrics derived from a patient's physiological activity (e.g., pulse rate, breathing rate).

In some embodiments, a dynamic threshold magnitude may be set based at least in part on surrounding data points in the scalogram. In some embodiments, a region of high energy may be defined as all points having a magnitude that is a certain percentage above or below the mean or median of the magnitude of all energy points in a scalogram or portion of a scalogram. For example, the mean energy magnitude for points in a scalogram may be determined, and a region of high energy may be identified as all the points with an energy magnitude that exceeds the mean by at least 25%. In some embodiments, a region of high energy may be identified as the locus of points having energy values within a certain percentage of the highest energy magnitude in the scalogram. For example, a region of high energy may include all the points with an energy magnitude within 5% of the maximum energy magnitude in the scalogram. Any other suitable technique for identifying a region of relative high energy may be used.

In some embodiments, a range of scales may be scanned for a region of high energy when certain physiological information is expected within that range. One or more appropriate ranges of scales for different types of signals may be retrieved from a storage device, such as ROM 52 or RAM 54. In some embodiments, the breathing rate, pulse rate, or both of a patient may be of interest, and a range of scales where a breathing band is expected, a range of scales where a pulse band is expected, or both may be scanned prior to scanning other ranges of scales in the scalogram. Scanning the expected ranges first may make the process of identifying a region of high energy more efficient. For example, if the expected range for a breathing band is scanned before other scale ranges, a region of high energy identified in the expected range may be determined to be the breathing band. The absence of a region of high energy in the expected range may be a way to determine that the patient has stopped breathing or is breathing irregularly.

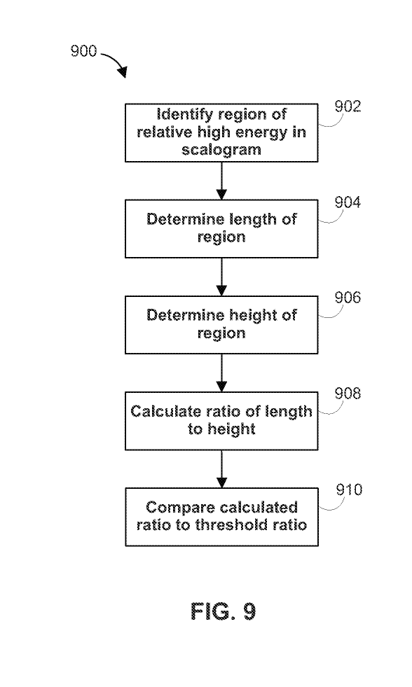

In some embodiments, dimension information may be determined in step 710 regarding the region of relative high energy identified in step 708. For example, processor 412 or microprocessor 48 may measure the height of the region along the scale axis of the scalogram and the length of the region along the time axis of the scalogram. Any suitable measurement may be used, such as a maximum distance, average distance, or weighted average distance. Determining dimension information is discussed in more detail below in relation to FIG. 9.

In some embodiments, at least some of the dimension information determined in step 710 may be processed in step 712 to determine physiological information about the patient. In some embodiments, the ratio of the length to the height of the region of high energy may be calculated. In some embodiments, processor 412 or microprocessor 48 may calculate the ratio. The ratio may be used to determine physiological information, such as whether the patient is still breathing, whether the patient has a steady pulse, or both depending on which regions are being analyzed. For example, in a scalogram that includes a range of scales in which breathing information is expected, a region of high energy in that range with a higher ratio may indicate a more stable breathing rate. In a scalogram that includes a range of scales in which pulse information is expected, a region of high energy in that range with a higher ratio may indicate a more stable pulse. Steps for analyzing and processing dimension information are discussed in more detail below in relation to FIG. 9.

In some embodiments, the physiological information determined in step 712 may be stored in step 714. For example, the information may be stored in ROM 52 or RAM 54 (FIG. 2). In some embodiments, the information may be displayed on a display device, such as display 28 (FIG. 1) or 20 (FIG. 2).

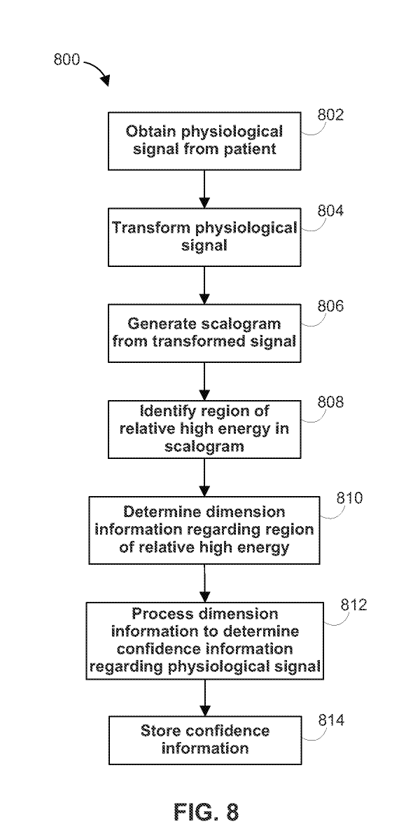

FIG. 8 is a flow chart 800 of illustrative steps for analyzing a physiological signal to determine confidence information in accordance with some embodiments. The steps of flow chart 800 may be performed by processor 412, or may be performed by any suitable processing device communicatively coupled to monitor 14. The steps of flow chart 800 may be performed by a digital processing device, or implemented in analog hardware. It will be noted that the steps of flow chart 800 may be performed in any suitable order, and certain steps may be omitted entirely.

At step 802, a physiological signal may be obtained from a patient. The physiological signal may be obtained from patient 40 using sensor 12 or input signal generator 410 in real time, or may be received as input signal 416. In some embodiments, the physiological signal may have been stored in ROM 52, RAM 54, and/or QSM 72 (FIG. 2) in the past and may be accessed by microprocessor 48 within monitor 14 to be processed. The physiological signal may be, for example, a plethysmograph signal.

In some embodiments, the physiological signal obtained at step 802 may be transformed in step 804. A transformation may occur in conjunction with the obtaining at step 802, or after the signal is obtained at step 802. In some embodiments, processor 412 may transform the signal into a wavelet domain. This transformation may be performed by any one or more of the transformation techniques described herein, including a continuous wavelet transformation. The continuous wavelet transform function may be based at least in part on a wavelet function, as described above (e.g., Morlet, Mexican Hat, Haar, any other suitable wavelet, or any combination thereof). This transformation may be performed by any suitable processing device, such as processor 412 and/or microprocessor 48, which may each be a general-purpose computing device or a specialized processor. The transformation may also be performed by a separate, dedicated device.

In some embodiments, a scalogram may be generated in step 806 based at least in part on the transformation of the physiological signal obtained at step 802. A scalogram may be generated by any of the techniques described herein. In some embodiments, a scalogram may be based at least in part on any one or more features of a transformed signal. For example, a scalogram may represent the real part of a transformed signal, the imaginary part of a transformed signal, the modulus of a transformed signal, any other suitable feature of the transformed signal, or any combination thereof.

In some embodiments, a region of relative high energy may be identified in step 808 in the scalogram generated in step 806. For example, processor 412 or microprocessor 48 may compare the magnitudes of energies in the scalogram and identify a locus of points of local maxima of energy values. In some embodiments, the boundaries of a region of high energy may be established based at least in part on threshold magnitude values. For example, a region of high energy may be identified as all the points with an energy magnitude that exceeds a preset threshold magnitude. The threshold magnitude may be set based at least in part on historical or empirical data collected from one or more patients. In some embodiments, the threshold magnitude may be set based at least in part on one or more metrics derived from a patient's physiological activity (e.g., pulse rate, breathing rate).

In some embodiments, a dynamic threshold magnitude may be set based at least in part on surrounding data points in the scalogram. In some embodiments, a region of high energy may be defined as all points having a magnitude that is a certain percentage above or below the mean or median of the magnitude of all energy points in a scalogram. For example, the mean energy magnitude for points in a scalogram may be determined, and a region of high energy may be identified as all the points with an energy magnitude that exceeds the mean by at least 25%. In some embodiments, a region of high energy may be identified as the locus of points having energy values within a certain percentage of the highest energy magnitude in the scalogram. For example, a region of high energy may include all the points with an energy magnitude within 5% of the maximum energy magnitude in the scalogram. Any other suitable technique for identifying a region of relative high energy may be used.

In some embodiments, a range of scales may be scanned for a region of high energy when certain physiological information is expected within that range. One or more appropriate ranges of scales for different types of signals may be retrieved from a storage device, such as ROM 52 or RAM 54. In some embodiments, the breathing rate, pulse rate, or both of a patient may be of interest, and a range of scales where a breathing band is expected, a range of scales where a pulse band is expected, or both may be scanned prior to scanning other ranges of scales in the scalogram. Scanning the expected ranges first may make the process of identifying a region of high energy more efficient. For example, if the expected range for a breathing band is scanned before other scale ranges, a region of high energy identified in the expected range may be determined to be the breathing band. The absence of a region of high energy in the expected range may be a way to determine that the patient has stopped breathing or is breathing irregularly.

In some embodiments, dimension information may be determined in step 810 regarding the region of relative high energy identified in step 808. For example, processor 412 or microprocessor 48 may measure the height of the region along the scale axis of the scalogram and the length of the region along the time axis of the scalogram. Any suitable measurement may be used, such as a maximum distance, average distance, or weighted average distance. Determining dimension information is discussed in more detail below in relation to FIG. 9.

In some embodiments, at least some of the dimension information determined in step 810 may be processed in step 812 to determine confidence information regarding the physiological signal. In some embodiments, the ratio of the length to the height of the region of high energy may be calculated. In some embodiments, processor 412 or microprocessor 48 may calculate the ratio. The calculated ratio may be compared to a threshold ratio to obtain more information about the stability or accuracy of the signal. For example, in a scalogram that includes a range of scales in which breathing information is expected, a region of high energy in that range with a calculated ratio that far exceeds the threshold ratio may reliably indicate that the patient is breathing very steadily. In a scalogram that includes a range of scales in which pulse information is expected, a region of high energy in that range with a calculated ratio that far exceeds the threshold ratio may reliably indicate that the patient has a stable pulse. Steps for analyzing and processing dimension information are discussed in more detail below in relation to FIG. 9.

In some embodiments, the confidence information determined in step 812 may be stored in step 814. For example, the information may be stored in ROM 52 or RAM 54 (FIG. 2). In some embodiments, the information may be displayed on a display device, such as display 28 (FIG. 1) or 20 (FIG. 2).

FIG. 9 is a flow chart 900 of illustrative steps for analyzing and processing information from a scalogram in accordance with some embodiments. One or more steps of flow chart 900 may be performed as a part of or in addition to the steps described above in relation to FIGS. 7-8. For example, steps 904-908, described below, may be performed as part of or in addition to step 710 and/or 810 (determine dimension information regarding region of relative high energy). Step 910, described below, may be performed as part of or in addition to a step of processing dimension information (e.g., step 712 and/or 812). The steps of flow chart 900 may be performed by processor 412, or may be performed by any suitable processing device communicatively coupled to monitor 14. The steps of flow chart 900 may be performed by a digital processing device, or implemented in analog hardware. It will be noted that the steps of flow chart 900 may be performed in any suitable order, and certain steps may be omitted entirely.

In some embodiments, a region of relative high energy may be identified in step 902. For example, processor 412 or microprocessor 48 may identify a locus of points of local maxima of energy values in the scalogram using any suitable technique discussed herein.

In some embodiments, the length of the region identified in step 902 may be determined in step 904. For example, processor 412 or microprocessor 48 may measure the length of the region along the time axis of the scalogram. Any suitable measurement may be used. For example, the length may be determined to be the greatest point-to-point length of the region of high energy, or the average point-to-point length of the region of high energy. In some embodiments, the length may be a weighted average of point-to-point lengths of the region of high energy. For example, point-to-point lengths closer to the center of the region of high energy may be weighted more heavily in calculating the length of the region of high energy than point-to-point lengths farther away from the center. In some embodiments, the length may be determined by summing all the points of a particular scale across the time axis and counting all the points whose energy exceeds a predefined or calculated threshold. Multiple lengths may then be averaged, if desired, by performing the same operation on any suitable number of adjacent scales.

In some embodiments, the height of the region identified in step 902 may be determined in step 906. For example, processor 412 or microprocessor 48 may measure the height of the region along the scale axis of the scalogram. Any suitable measurement may be used. For example, the height may be determined to be the greatest point-to-point height of the region of high energy, or the average point-to-point height of the region of high energy. In some embodiments, the height may be a weighted average of point-to-point heights of the region of high energy. For example, point-to-point heights closer to the center of the region of high energy may be weighted more heavily in calculating the height of the region of high energy than point-to-point heights farther away from the center. In some embodiments, the height may be determined by summing all the points of a particular time across the scale axis and counting all the points whose energy exceeds a predefined or calculated threshold. Multiple heights may then be averaged, if desired, by performing the same operation on any suitable number of adjacent points in time.

In some embodiments, the ratio of the length determined in step 904 and height determined in step 906 may be calculated in step 908. In some embodiments, processor 412 or microprocessor 48 may calculate the ratio using any suitable technique. In general, higher ratios indicate input signals with a more concentrated range of frequencies and longer duration, i.e. a “cleaner” signal. Higher ratios tend to be associated with regions of high energy that are thin and rectangular in shape. Lower ratios indicate input signals with random durations and are associated with scalograms having more distributed energy.

In some embodiments, the ratio calculated in step 908 may be compared to a threshold ratio in step 910. For example, processor 412 or microprocessor 48 may compare the ratios using any suitable technique. In some embodiments, historic and/or empirical data may be analyzed to determine an appropriate threshold ratio. For example, historical data regarding the patient's breathing rate may be used to determine approximate ratios for when the patient was breathing and when the patient was not breathing. An appropriate threshold value may be determined such that calculated ratios exceeding the value indicate a strong likelihood that the patient is still breathing. In this way, a patient's personal medical history may be used to “train” medical equipment. In other embodiments, an appropriate threshold value may be determined using data collected from a general population instead of a specific patient. In some embodiments, the threshold ratio may be retrieved from a storage device, such as ROM 52 or RAM 54 (FIG. 2). For example, a patient/subject database that includes “gold references” may be used to compare a calculated ratio against known values and/or a predetermined threshold ratio.

In some embodiments, the threshold ratio may be set based at least in part on an analysis of Receiver Operating Characteristic (ROC) curves. For example, a series of ROC curves may be established for various threshold ratios. The threshold whose ROC curve maximizes sensitivity (i.e., true positives) and specificity (i.e., proportion of negative results that are correctly identified) may be used. In some embodiments, it may be desirable to maximize detection of valid physiological signals or apnea, while minimizing false positives. For example, the occurrence of apnea (i.e., suspension of breathing) in a patient may be designated as a positive. A true positive would be an instance when a comparison of a calculated ratio to a threshold ratio indicates that the patient is not breathing, and the patient is actually not breathing. A false positive would be an instance when a comparison of ratios indicates that the patient is not breathing, but the patient is actually still breathing.

The difference between a calculated ratio and an appropriate threshold ratio may indicate a confidence level of further analyzing or relying on the input signal. A calculated ratio that far exceeds the threshold ratio may indicate an extremely reliable signal that is stationary, stable, and accurate. A calculated ratio below the threshold ratio may indicate that the signal is an artifact, is inconsistent, has been overwhelmed by noise, or has stopped, so the signal should not be relied upon. Such a signal may indicate that a better measurement is needed or that another signal should be examined.

In some embodiments, the absence in a scalogram of a region of high energy indicative of a patient's consistent physiological pulse or consistent respiration may trigger an alarm to indicate that the patient may be experiencing physiological problems (e.g., arrhythmia, lost pulse, labored/irregular breathing, or no breathing). The alarm may be audible (e.g., siren or beeping sound) or visual (e.g., flashing light or light changing color), or both. In some embodiments, the value of the calculated ratio of the length to the height of a region of high energy in a scalogram (e.g., the calculation performed in step 908) may be used to determine whether an alarm should be triggered. For example, the calculated ratio may be compared with empirical data to determine if the calculated ratio is within a range typical of a patient that is breathing (in which case an alarm may not be triggered), or of a patient that is not breathing (in which case an alarm may be triggered). In some embodiments, an alarm may be triggered if the calculated ratio falls below a threshold ratio. In some embodiments, the value of the calculated ratio may be used to identify the occurrence or presence of a particular physiological condition (e.g., arrhythmia, lost pulse, labored/irregular breathing, or no breathing). The identified condition may, for example, be indicated to a clinician via a status message on a display. This identification may be based at least in part on empirical data related to the ratio and may also be based at least in part on other metrics. In one suitable approach, one or more neural networks may be used to process the calculated ratio and other metrics to determine the existence of one or more conditions.

The steps discussed above in relation to FIGS. 7-9 may be used, for example, to analyze the continuous wavelet transform of an “up/down” signal to determine if a patient is breathing or not. Techniques for constructing and analyzing “up/down” signals are described in Addison et al., U.S. application Ser. No. 12/437,311, filed May 7, 2009, entitled “SIGNAL PROCESSING MIRRORING TECHNIQUE”, which is incorporated by reference herein in its entirety. A high ratio for the signal would indicate the presence of a breathing signal, whereas a low ratio would indicate that breathing has ceased. In some embodiments, the steps discussed above may also be used in conjunction with baseline modulation of signals. The concept of comparing calculated and threshold ratios may be extended to other signals, physiological or otherwise, to indicate the presence or “goodness” of a signal.

The above described embodiments of the present disclosure are presented for purposes of illustration and not of limitation, and the present disclosure is limited only by the claims which follow.

What is claimed is:

1. A system for analyzing a physiological signal obtained from a patient, the system comprising:
electronic processing equipment capable of:
transforming the physiological signal using a continuous wavelet transform to generate a transformed signal,
generating a scalogram based at least in part on the transformed signal,
identifying a region of relative high energy in the scalogram,
determining dimension information regarding the region, and
processing the dimension information to determine physiological information about the patient; and
a storage device coupled to the electronic processing equipment for storing the physiological information.

2. The system of claim 1, further comprising a display device coupled to the storage device on which the physiological information is displayed.

3. The system of claim 1, wherein the identifying comprises searching for a region of relative high energy in a range of scales associated with respiration.

4. The system of claim 1, wherein:
the dimension information comprises length information and width information;
the length information comprises a length of the region along a time axis of the scalogram;
the width information comprises a width of the region along a scale axis of the scalogram; and
the processing comprises calculating a ratio of the length to the width.

5. The system of claim 4, wherein the electronic processing equipment is further capable of comparing the calculated ratio to a threshold ratio.

6. The system of claim 5, wherein the electronic processing equipment is further capable of determining a respiration state of the patient based on the comparison.

7. A system for analyzing a physiological signal obtained from a patient, the system comprising:
electronic processing equipment capable of:
transforming the physiological signal using a continuous wavelet transform to generate a transformed signal,
generating a scalogram based at least in part on the transformed signal,
identifying a region of relative high energy in the scalogram,
determining dimension information regarding the region,
processing the dimension information to determine confidence information regarding the physiological signal; and
a storage device coupled to the electronic processing equipment for storing the confidence information.

8. The system of claim 7, further comprising a display device coupled to the storage device on which the confidence information is displayed.

9. The system of claim 7, wherein:
the dimension information comprises length information and width information;
the length information comprises a length of the region along a time axis of the scalogram;
the width information comprises a width of the region along a scale axis of the scalogram; and
the processing comprises calculating a ratio of the length to the width.

10. The system of claim 9, wherein the storage device further stores signal information, wherein the signal information comprises appropriate ranges of scales on the scalogram for different types of signals.

11. The system of claim 9, wherein the electronic processing equipment is further capable of comparing the calculated ratio to a threshold ratio.

12. The system of claim 11, wherein the determining of confidence information comprises assigning a level of confidence to the physiological signal proportional to the difference between the calculated ratio and the threshold ratio.

13. The system of claim 7, wherein the electronic processing equipment is further capable of processing the dimension information to determine physiological information.

14. A method for analyzing a physiological signal obtained from a patient, the method comprising:
using electronic processing equipment to:
transform the physiological signal using a continuous wavelet transform to generate a transformed signal,
generate a scalogram based at least in part on the transformed signal,
identify a region of relative high energy in the scalogram,
determine dimension information regarding the region, and
process the dimension information to determine physiological information about the patient; and
storing the physiological information in a storage device.

15. The method of claim 14, further comprising displaying the physiological information on a display device.

16. The method of claim 14, wherein the identifying comprises searching for a region of relative high energy in a range of scales associated with respiration.

17. The method of claim 14, wherein:
the dimension information comprises length information and width information;
the length information comprises a length of the region along a time axis of the scalogram;
the width information comprises a width of the region along a scale axis of the scalogram; and
the processing comprises calculating a ratio of the length to the width.

18. The method of claim 17, further comprising comparing the calculated ratio to a threshold ratio.

19. The method of claim 18, further comprising determining a respiration state of the patient based on the comparison.
